(19) United States
(12) Patent Application Publication
(10) Pub. No.: US 2021/0067679 A1
(43) Pub. Date: Mar. 4, 2021

(54) EVENT SENSORS WITH FLICKER ANALYSIS CIRCUITRY

(71) Applicant: SEMICONDUCTOR COMPONENTS INDUSTRIES, LLC, Phoenix, AZ (US)

(72) Inventor: James TORNES, Santa Clara, CA (US)

(73) Assignee: SEMICONDUCTOR COMPONENTS INDUSTRIES, LLC, Phoenix, AZ (US)

(21) Appl. No.: 16/794,573

(22) Filed: Feb. 19, 2020

Related U.S. Application Data
(60) Provisional application No. 62/892,830, filed on Aug. 28, 2019.

(51) Int. Cl. H04N 5/235

(52) U.S. Cl. CPC H04N 5/2357; H04N 5/2351

(57) ABSTRACT

An imaging system may include an event sensor with event sensor pixels. The event sensor pixels may be configured to trigger an “event” if the intensity of light at a pixel changes. Pulse-width modulated light-emitting diode (LED) lighting can cause the image from an event sensor to undulate frame to frame. This may result in false positives when detecting events (because the LED flickering triggers events for the event sensor even though the scene is unchanging to a human viewer). Therefore, the imaging system may include flicker analysis circuitry that is configured to receive light intensity signals from an event sensor pixel. Based on the light intensity signals and the times associated with changes in the light intensity signals, the flicker analysis circuitry may determine an average brightness associated with the LED.

This application claims the benefit of provisional patent application No. 62/892,830, filed Aug. 28, 2019, which is hereby incorporated by reference herein in its entirety.

### BACKGROUND

This relates generally to imaging sensors, and more specifically, to event sensors.

Conventional imaging sensors measure the intensity of light across an array of pixels to form an image. In contrast, event sensors detect whether the intensity of light has changed in each pixel in the sensor. This may allow for high temporal resolution, high dynamic range, and reduced motion blur.

Pulse-width modulated light-emitting diode (LED) lighting can cause the image from a conventional event sensor to undulate frame to frame. This may result in false positives when detecting events (because the LED flickering triggers events for the event sensor even though the scene is unchanging to a human viewer).

It would therefore be desirable to provide improved event sensors.

### BRIEF DESCRIPTION OF THE DRAWINGS

FIG. 1 is a diagram of an illustrative electronic device having an image sensor in accordance with an embodiment.

FIG. 2 is a diagram of an illustrative pixel array and associated readout circuitry for reading out image signals in an image sensor in accordance with an embodiment.

FIG. 3 is a graph showing light-emitting diode (LED) brightness over time relative to image sensor exposure periods in accordance with an embodiment.

FIG. 4 is a schematic diagram of an illustrative system that includes an event sensor pixel with event detection and flicker analysis circuitry in accordance with an embodiment.

FIG. 5 is a schematic diagram of an illustrative system that includes an event sensor pixel that outputs data to control and processing circuitry that includes event detection and flicker analysis circuitry in accordance with an embodiment.

FIG. 6 is a schematic diagram of an illustrative system that includes an event sensor pixel with event detection circuitry and control and processing circuitry with flicker analysis circuitry in accordance with an embodiment.

FIG. 7 is a schematic diagram of an illustrative system showing how flicker analysis circuitry outputs an average effective LED brightness based on light intensity signals and time stamps from an event sensor pixel in accordance with an embodiment.

FIG. 8 is a flowchart showing an illustrative method for operating a system with event sensor pixels and flicker analysis circuitry such as the system of FIG. 7 in accordance with an embodiment.

FIG. 9 is a schematic diagram of an illustrative system that includes a low-resolution event sensor, a high-resolution high dynamic range (HDR) sensor, and flicker analysis circuitry in accordance with an embodiment.

FIG. 10 is a flowchart showing an illustrative method for operating a system with a low-resolution event sensor, a high-resolution HDR sensor, and flicker analysis circuitry such as the system of FIG. 9 in accordance with an embodiment.

### DETAILED DESCRIPTION

Embodiments of the present invention relate to image sensors. It will be recognized by one skilled in the art that the present exemplary embodiments may be practiced without some or all of these specific details. In other instances, well-known operations have not been described in detail in order not to unnecessarily obscure the present embodiments.

Electronic devices such as digital cameras, computers, cellular telephones, and other electronic devices may include image sensors that gather incoming light to capture an image. The image sensors may include arrays of pixels. The pixels in the image sensors may include photosensitive elements such as photodiodes that convert the incoming light into light intensity signals. Image sensors may have any number of pixels (e.g., hundreds or thousands or more). A typical image sensor may, for example, have hundreds of thousands or millions of pixels (e.g., megapixels). Image sensors may include control circuitry such as circuitry for operating the pixels and readout circuitry for reading out image signals corresponding to the electric charge generated by the photosensitive elements.

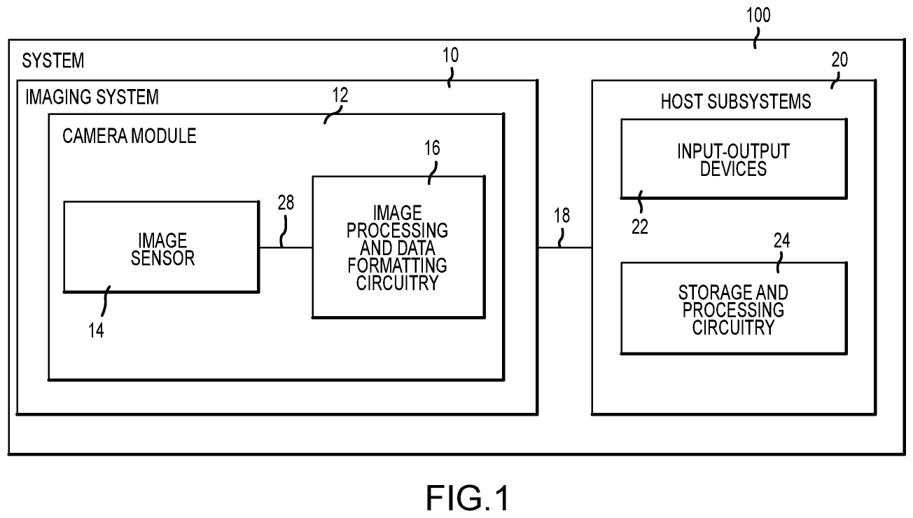

FIG. 1 is a diagram of an illustrative imaging and response system including an imaging system that uses an image sensor to capture images. System 100 of FIG. 1 may be an electronic device such as a camera, a cellular telephone, a video camera, or other electronic device that captures digital image data, may be a vehicle safety system (e.g., an active braking system or other vehicle safety system), may be a surveillance system, or may be any other desired type of system.

In a vehicle safety system, data from the image sensor may be used by the vehicle safety system to determine environmental conditions surrounding the vehicle. As examples, vehicle safety systems may include systems such as a parking assistance system, an automatic or semi-automatic cruise control system, an auto-braking system, a collision avoidance system, a lane keeping system (sometimes referred to as a lane drift avoidance system), a pedestrian detection system, etc. In at least some instances, an image sensor may form part of a semi-autonomous or autonomous self-driving vehicle. System 100 may also be used for medical imaging, surveillance, and general machine vision applications.

As shown in FIG. 1, system 100 may include an imaging system such as imaging system 10 and host subsystems such as host subsystem 20. Imaging system 10 may include camera module 12. Camera module 12 may include one or more image sensors 14 and one or more lenses.

Each image sensor in camera module 12 may be identical or there may be different types of image sensors in a given image sensor array integrated circuit. During image capture operations, each lens may focus light onto an associated image sensor 14. Image sensor 14 may include photosensitive elements (i.e., pixels) that convert the light into digital data. Image sensors may have any number of pixels (e.g., hundreds, thousands, millions, or more). A typical image sensor may, for example, have millions of pixels (e.g., megapixels). As examples, image sensor 14 may include bias circuitry (e.g., source follower load circuits), sample and hold circuitry, correlated double sampling (CDS) circuitry, amplifier circuitry, analog-to-digital converter circuitry, data output circuitry, memory (e.g., buffer circuitry), address circuitry, etc.

Still and video image data from camera sensor 14 may be provided to image processing and data formatting circuitry 16 via path 28. Path 28 may be a connection through a serializer/deserializer (SERDES) which is used for high speed communication and may be especially useful in automotive systems. Image processing and data formatting circuitry 16 may be used to perform image processing functions such as data formatting, adjusting white balance and exposure, implementing video image stabilization, face detection, etc. Machine learning may be used by image processing circuitry 16 to process the received image data. Image processing and data formatting circuitry 16 may also be used to compress raw camera image files if desired (e.g., to Joint Photographic Experts Group or JPEG format). In a typical arrangement, which is sometimes referred to as a system on chip (SOC) arrangement, camera sensor 14 and image processing and data formatting circuitry 16 are implemented on a common semiconductor substrate (e.g., a common silicon image sensor integrated circuit die). If desired, camera sensor 14 and image processing circuitry 16 may be formed on separate semiconductor substrates. For example, camera sensor 14 and image processing circuitry 16 may be formed on separate substrates that have been stacked.

Imaging system 10 (e.g., image processing and data formatting circuitry 16) may convey acquired image data to host subsystem 20 over path 18. Path 18 may also be a connection through SERDES. Host subsystem 20 may include processing software for detecting objects in images, detecting motion of objects between image frames, determining distances to objects in images, and/or filtering or otherwise processing images provided by imaging system 10.

If desired, system 100 may provide a user with numerous high-level functions. In a computer or advanced cellular telephone, for example, a user may be provided with the ability to run user applications. To implement these functions, host subsystem 20 of system 100 may have input-output devices 22 such as keypads, input-output ports, buttons, joysticks, and displays and storage and processing circuitry 24. Storage and processing circuitry 24 may include volatile and nonvolatile memory (e.g., random-access memory, flash memory, hard drives, solid-state drives, etc.). Storage and processing circuitry 24 may also include microprocessors, microcontrollers, digital signal processors, application specific integrated circuits, etc.

One or more of the image sensors 14 in the imaging system may be event sensors. An event sensor may be configured to trigger an “event” if the intensity of light at a pixel changes. If the intensity of light hitting a pixel does not change, then the pixel does not generate any events. If a pixel has a first intensity and changes to a second, different intensity, it is concluded that an event has occurred at that pixel (because the scene has changed intensity). There may be a threshold within which pixel intensity is considered the same (e.g., light intensity signals within 5% of each other, within 1% of each other, within 0.1% of each other, etc.). Events are detected on a per-pixel basis.

There are numerous ways to arrange pixels in event sensors. In some cases, each pixel in an event sensor may include circuitry that is configured to determine whether or not an event has occurred. In this type of arrangement, the pixel may output a binary signal that indicates whether or not an event has occurred (e.g., a 1 is output to indicate an event has occurred and a 0 is output to indicate that an event has not occurred) and/or time stamps of when events occur. Alternatively, the pixel may output a light intensity signal. Additional processing circuitry formed outside of the pixel may analyze the light intensity signal to evaluate whether or not an event has occurred.

The light intensity signal output from an event sensor pixel may also have numerous possible forms. In one embodiment, the pixel may accumulate charge over an integration time. For example, charge accumulates in a photodiode and is then transferred to a floating diffusion region using a transfer transistor. A source follower transistor coupled to the floating diffusion region may be used for readout of the light intensity signal. In this example, the light intensity signal is equal to the amount of charge generated over a given integration time. If the same integration time is used for multiple exposures of the same pixel, the amount of charge (e.g., the light intensity signal) for each exposure may be compared to determine whether or not an event has occurred.

In another possible arrangement, the event sensor pixel may include circuitry for determining an instantaneous measure of light intensity. The light intensity signal may be equivalent to a photocurrent of the pixel at any given point in time. The photocurrent at a first time may be compared to the photocurrent at a second time. The photocurrent magnitudes may be compared to determine whether or not an event has occurred.

In other words, light intensity may be measured in an instantaneous fashion (e.g., as a photocurrent at a given time) or may be averaged over a given period of time (e.g., charge accumulation over an integration time, average photocurrent over the given period of time, etc.). The type of light intensity signal used by the event sensor may be depend upon the particular application and specific design constraints of the sensor.

The imaging system 100 may include frame-based image sensors in addition to event sensors. Frame-based image sensors may refer to image sensors that generate high-resolution images based on an integration time. In yet another possible arrangement, a single image sensor may include both event-based pixels and frame-based pixels.

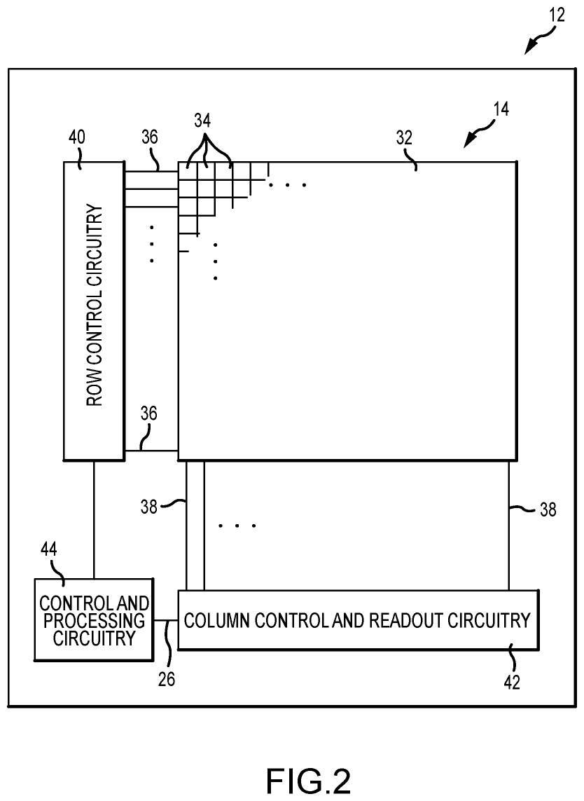

An example of an arrangement for camera module 12 of FIG. 1 is shown in FIG. 2. As shown in FIG. 2, camera module 12 includes image sensor 14 and control and processing circuitry 44. Control and processing circuitry 44 may correspond to image processing and data formatting circuitry 16 in FIG. 1. Image sensor 14 may include a pixel array such as array 32 of pixels 34 (sometimes referred to herein as image sensor pixels, imaging pixels, or image pixels 34) and may also include control circuitry 40 and 42. Image sensor 14 may be either a frame-based image sensor or an event sensor. Control and processing circuitry 44 may be coupled to row control circuitry 40 and may be coupled to column control and readout circuitry 42 via data path 26. Row control circuitry 40 may receive row addresses from control and processing circuitry 44 and may supply corresponding row control signals to image pixels 34 over control paths 36 (e.g., dual conversion gain control signals, pixel reset control signals, charge transfer control signals, blooming control signals, row select control signals, or any other desired pixel control signals). Column control and readout circuitry 42 may be coupled to the columns of pixel array 32 via one or more conductive lines such as column lines 38. Column lines 38 may be coupled to each column of image pixels 34 in image pixel array 32 (e.g., each column of pixels may be coupled to a corresponding column line 38). Column lines 38 may be used for reading out image signals from image pixels 34 and for supplying bias signals (e.g., bias currents or bias voltages) to image pixels 34. During image pixel readout operations, a pixel row in image pixel array 32 may be selected using row control circuitry 40 and image data associated with image pixels 34 of that pixel row may be read out by column control and readout circuitry 42 on column lines 38.

Column control and readout circuitry 42 may include column circuitry such as column amplifiers for amplifying signals read out from array 32, sample and hold circuitry for sampling and storing signals read out from array 32, analog-to-digital converter circuits for converting read out analog signals to corresponding digital signals, and column memory for storing the read out signals and any other desired data. Column control and readout circuitry 42 may output digital pixel values to control and processing circuitry 44 over line 26.

Array 32 may have any number of rows and columns. In general, the size of array 32 and the number of rows and columns in array 32 will depend on the particular implementation of image sensor 14. While rows and columns are generally described herein as being horizontal and vertical, respectively, rows and columns may refer to any grid-like structure (e.g., features described herein as rows may be arranged vertically and features described herein as columns may be arranged horizontally).

Pixel array 32 may be provided with a color filter array having multiple color filter elements which allows a single image sensor to sample light of different colors. As an example, image sensor pixels such as the image pixels in array 32 may be provided with a color filter array which allows a single image sensor to sample red, green, and blue (RGB) light using corresponding red, green, and blue image sensor pixels arranged in a Bayer mosaic pattern. The Bayer mosaic pattern consists of a repeating unit cell of two-by-two image pixels, with two green image pixels diagonally opposite one another and adjacent to a red image pixel diagonally opposite to a blue image pixel. In another suitable example, the green pixels in a Bayer pattern are replaced by broadband image pixels having broadband color filter elements (e.g., clear color filter elements, yellow color filter elements, etc.). The image sensor may also be a monochrome sensor (e.g., with every pixel covered by a color filter element of the same color). These examples are merely illustrative and, in general, color filter elements of any desired color and in any desired pattern may be formed over any desired number of image pixels 34.

If desired, array 32 may be part of a stacked-die arrangement in which pixels 34 of array 32 are split between two or more stacked substrates. In such an arrangement, each of the pixels 34 in the array 32 may be split between the two dies at any desired node within the pixel. As an example, a node such as the floating diffusion node may be formed across two dies. Pixel circuitry that includes the photodiode and the circuitry coupled between the photodiode and the desired node (such as the floating diffusion node, in the present example) may be formed on a first die, and the remaining pixel circuitry may be formed on a second die. The desired node may be formed on (i.e., as a part of) a coupling structure (such as a conductive pad, a micro-pad, a conductive interconnect structure, or a conductive via) that connects the two dies. Before the two dies are bonded, the coupling structure may have a first portion on the first die and may have a second portion on the second die. The first die and the second die may be bonded to each other such that first portion of the coupling structure and the second portion of the coupling structure are bonded together and are electrically coupled. If desired, the first and second portions of the coupling structure may be compression bonded to each other. However, this is merely illustrative. If desired, the first and second portions of the coupling structures formed on the respective first and second dies may be bonded together using any metal-to-metal bonding technique, such as soldering or welding.

As mentioned above, the desired node in the pixel circuit that is split across the two dies may be a floating diffusion node. Alternatively, the desired node in the pixel circuit that is split across the two dies may be the node between a floating diffusion region and the gate of a source follower transistor (i.e., the floating diffusion node may be formed on the first die on which the photodiode is formed, while the coupling structure may connect the floating diffusion node to the source follower transistor on the second die), the node between a floating diffusion region and a source-drain node of a transfer transistor (i.e., the floating diffusion node may be formed on the second die on which the photodiode is not located), the node between a source-drain node of a source follower transistor and a row select transistor, or any other desired node of the pixel circuit.

In general, array 32, row control circuitry 40, column control and readout circuitry 42, and control and processing circuitry 44 may be split between two or more stacked substrates. In one example, array 32 may be formed in a first substrate and row control circuitry 40, column control and readout circuitry 42, and control and processing circuitry 44 may be formed in a second substrate. In another example, array 32 may be split between first and second substrates (using one of the pixel splitting schemes described above) and row control circuitry 40, column control and readout circuitry 42, and control and processing circuitry 44 may be formed in a third substrate.

Light-emitting diodes and other lighting may present challenges for operation of an image sensor. Light-emitting diodes emit light asynchronously. In other words, the light-emitting diodes have an associated frequency (e.g., 120 Hz). The light-emitting diodes alternate between on periods in which light is emitted and off periods in which light is not emitted. The human eye perceives these on and off periods as a uniform average intensity.

If care is not taken, an image sensor may output a first level in some frames and a second, different level in other frames when it captures a different number of pulses from the light-emitting diode (LED) on different frames, even though the scene is unchanging to the human eye. In an event sensor, this may result in events falsely identified even when the scene is unchanging to the human eye.

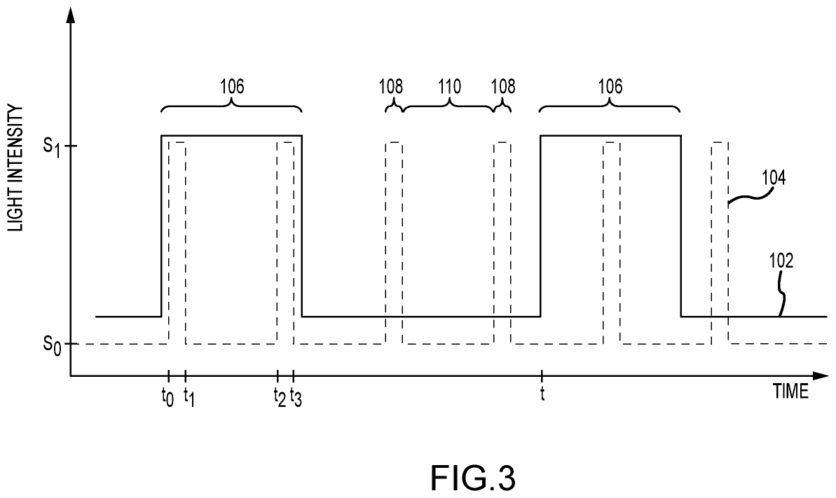

FIG. 3 is a timing diagram showing how the number of light-emitting diode pulses may vary between exposure periods of an image sensor. Solid line 102 shows the timing of exposure periods for the image sensor, whereas dashed line 104 shows the timing of light-emitting diode pulses in a light-emitting diode captured by the image sensor. As shown, the image sensor may have exposure periods 106 that are a certain length of time and occur at some frequency (e.g., 30 frames per second or some other desired frequency). Similarly, a light-emitting diode captured by the sensor may alternate between ‘on’ periods 108 (sometimes referred to as pulses or high periods) and ‘off’ periods 110 (sometimes referred to as low periods). During the pulses, the light-emitting diode may emit light. During the off periods, the light-emitting diode may not emit light.

As shown in FIG. 3, the number of LED pulses during each image sensor exposure period may vary. During the first exposure period, two LED pulses occur. During the second exposure period, only one LED pulse occurs. The image sensor may therefore sometimes measure an intensity associated with the LED that is twice as high during the first exposure than the second exposure. This change in intensity from frame to frame is undesirable when this sequence of images is shown to the user or recorded as a video because the brightness changes even though humans viewing the scene do not perceive a change in brightness.

An event sensor will generate an event every time an LED in the scene turns on and every time that LED turns off. Any motion in the scene will also generate events since the intensity of the pixels where an object is moving will trigger an event assuming the intensity of the object and the background are different.

An event sensor may therefore include flicker analysis circuitry that is capable of analyzing the outputs from the pixels and extrapolating the LED pattern/frequency. Using the LED pattern/frequency, the flicker analysis circuitry may determine an effective LED brightness of the captured LED. This effective LED brightness may be used to correct the image data such that the image data matches what is seen by the human eye.

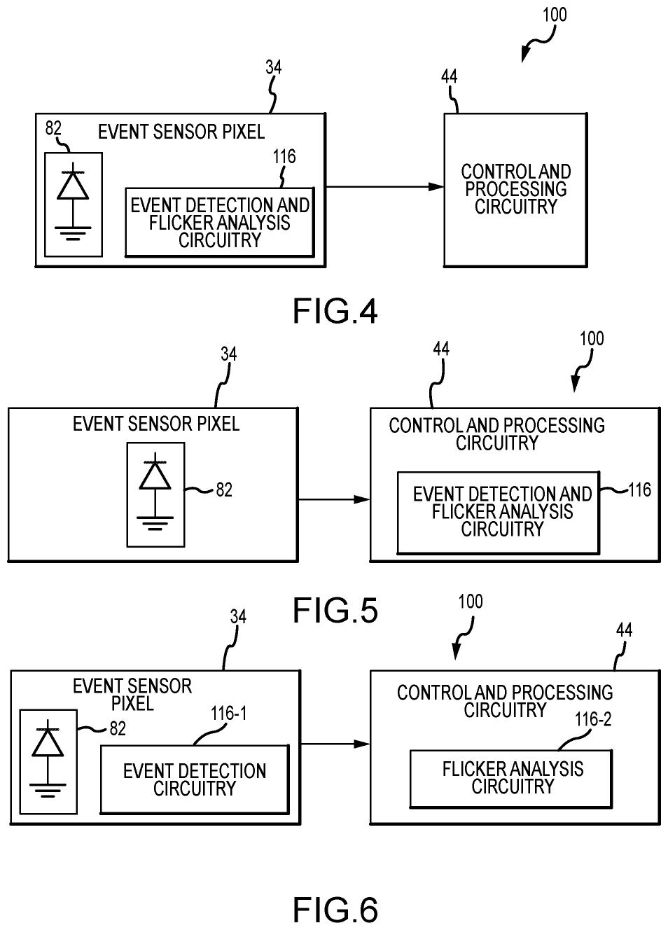

FIGS. 4-6 show illustrative systems with event sensor pixels and event detection and flicker analysis circuitry. As previously discussed, there are numerous options for how to integrate event detection circuitry with event sensor pixels. In the example of FIG. 4, imaging system 100 may include event sensor pixels 34 that each include a photodiode 82 and event detection and flicker analysis circuitry 116. In other words, each pixel 34 includes its own analysis circuit 116. Event detection and flicker analysis circuitry 116 may receive light intensity signals from photodiode 82. Event detection and flicker analysis circuitry 116 may analyze the light intensity signals and determine whether or not an event has occurred. Moreover, analysis circuitry 116 may be configured to correct the light intensity signals for flickering caused by light-emitting diodes (or other light sources) in the scene. Analysis circuitry 116 may also be configured to determine an average LED brightness associated with the LED.

The example of FIG. 4 of analysis circuitry being included in each event sensor pixel is merely illustrative. In another embodiment, shown in FIG. 5, each event sensor pixel 34 includes a photodiode 82. Light intensity signals may be output from the event sensor pixel 34 (e.g., based on a photocurrent from the photodiode) to event detection and flicker analysis circuitry 116 that is part of control and processing circuitry 44. In other words, the analysis circuitry 116 is not incorporated into each pixel itself, but instead receives data from the pixel at some location exterior to the pixel (e.g., at the periphery of the chip that includes the event sensor pixels, on a different chip than the chip that includes the event sensor pixels, etc.).

In yet another possible arrangement, the event detection circuitry and flicker analysis circuitry may be separated. As shown in FIG. 6, event sensor pixel 34 may include photodiode 82 and event detection circuitry 116-1. The event detection circuitry may identify when events occur using light intensity signals from the photodiode. The event detect detection circuitry may output the time stamps of detected events and the corresponding light intensity signals to control and processing circuitry 44. Flicker analysis circuitry 116-2 may receive the light intensity signals and time stamps and use this information to extrapolate the LED pattern/frequency. In cases where event sensor pixel 34 includes event detection circuitry, the event sensor pixel may only output data when an event is detected. As long as no event is detected, there is no output from the pixel.

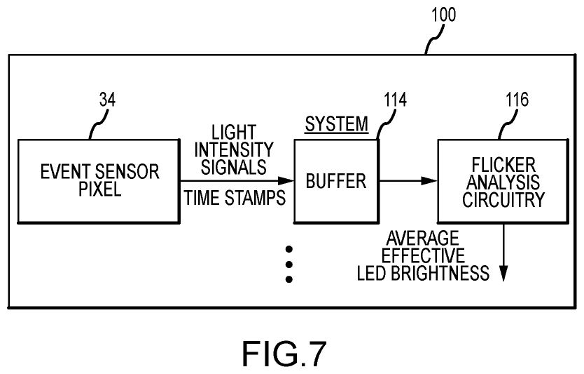

Regardless of the specific arrangement used, the flicker analysis circuitry may ultimately have inputs and outputs as shown in FIG. 7. As shown, each event sensor pixel 34 may output light intensity signals and time stamps. This information may optionally be provided to buffer 114. Buffer 114 may be a region of physical memory storage used to store events from the pixel. The memory may operate using any desired read/write scheme (e.g., random access memory).

Ultimately, flicker analysis circuitry receives information from the event sensor pixels including light intensity signals and time stamps. This information may be raw data (e.g., unprocessed by event detection circuitry) or may have already been processed by event detection circuitry. The flicker analysis circuitry may receive the light intensity signals and time stamps of light intensity changes and identify an LED frequency that is present in the data. The flicker analysis circuitry may use the identified LED frequency to avoid false positives when identifying events. In other words, the flicker analysis circuitry may remove false positive events that are caused only by LED flickering before the event sensor data is used for additional processing by the imaging system. Additionally, the flicker analysis circuitry may output an average effective LED brightness level. The effective LED brightness level may be determined based on the light intensity levels when the LED is on and off, as well as the duty cycle of the LED.

As an example of determining the effective LED brightness level, consider the example of FIG. 3. In FIG. 3, the LED brightness follows pattern 104, with on periods 108 and off periods 110. At t₀, the light intensity may change from S₀ (e.g., the ‘off’ brightness) to S₁ (e.g., the ‘on’ brightness). The LED remains on between to and t₁. At t₁, the light intensity drops from S₁ back to S₀. The LED remains off between t₁ and t₂.

Flicker mitigation circuitry may receive (e.g., from event detection circuitry or directly from the pixel as raw data) the brightness levels S₀ and S₁ as well as time stamps t₀, t₁, and t₂. The average brightness for each LED cycle is therefore determined by: (S₀*(t₁−t₀)+S₁*(t₂−t₀))/(t₂−t₀). In other words, the average brightness is determined using time-averaging for a single LED cycle (e.g., one on period and one off period). The resulting effective brightness is output from flicker analysis circuitry 116. The flicker analysis circuitry 116 may also output modified, undulation-free image data with the LED flickering events removed.

Each pixel may have an associated buffer 114 and flicker analysis circuitry 116. Alternatively, buffer 114 and/or flicker analysis circuitry 116 may optionally be shared between two or more pixels.

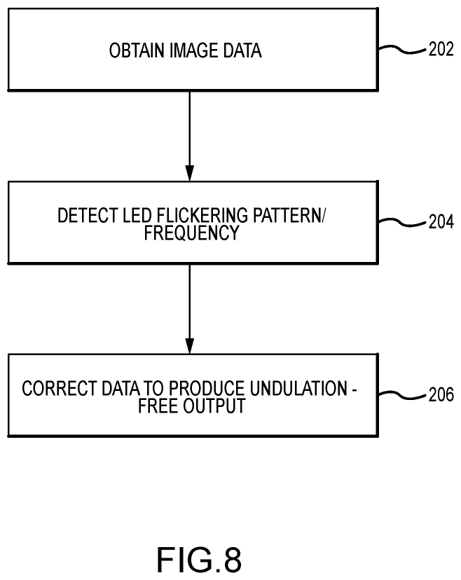

FIG. 8 is a flowchart of illustrative steps involved in operating a system with event sensor pixels of the type shown in FIG. 7. As shown, at step 202, image data (e.g., event time stamps and corresponding light intensity) may be obtained. The pixels in the event sensor may obtain image data and store the image data in a buffer such as buffer 114, for example. At step 204, a LED flickering pattern may be identified. Flicker analysis circuitry 116 may be used to identify the LED flickering pattern/frequency. After the LED flickering pattern is identified, the image data from the pixel may be corrected at step 206 to produce undulation-free output.

At step 206, the pixel data (optionally from buffer 114) may be analyzed by flicker analysis circuitry 116. Flicker analysis circuitry 116 may be configured to identify a LED flickering pattern/frequency in the data from the pixel stored in the buffer. The flicker analysis circuitry may use the identified LED flickering pattern to avoid incorrectly identifying an ‘event.’ Additionally, the flicker analysis circuitry may determine an average brightness that imitates the consistent brightness perceived the human eye (as opposed to the LED flickering that is detectable to the sensor pixels). The flicker analysis circuitry may output corrected image data that has the average LED brightness accounted for in each exposure, as opposed to having the LED fluctuations cause variance in the different exposures.

Once the flicker analysis circuitry 116 detects a LED flickering pattern, it may output an average signal that accounts for variance in the number of received LED pulses during each exposure period. The average signal may be a time-weighted average. The average signal produced by the flicker analysis circuitry may reflect the effective brightness of the LED. The average signal produced by the flicker analysis circuitry may remain constant (as long as the LED operating frequency remains the same), meaning that the output from the sensor 14 does not undergo undesired output undulations.

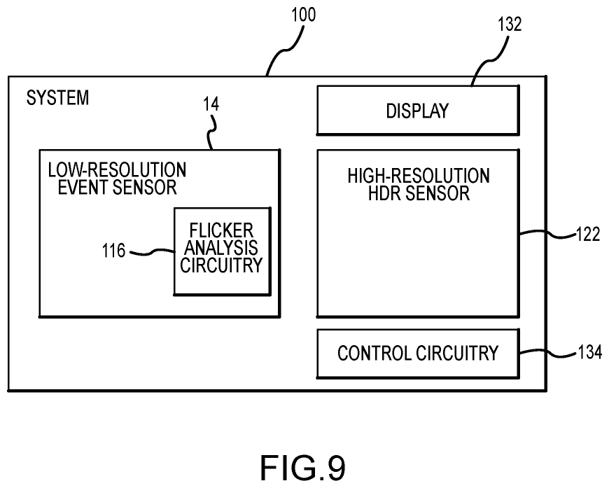

As shown in FIG. 9, a system 100 may include both an event sensor 14, an additional sensor 122, and a display 132. The image data from the event sensor 14 may be used to modify or correct data from sensor 122. Event sensor 14 may be a relatively low-resolution sensor, as the circuitry required for event detection may make the pixels relatively large. Including a relatively high-resolution sensor such as high-resolution high dynamic range (HDR) sensor 122 may allow for the imaging system to obtain more detailed images than if just event sensor 14 was included. In other words, sensor 122 has a higher resolution than sensor 14. The imaging system may include flicker analysis circuitry 116 as described in connection with FIGS. 4-8. The flicker analysis circuitry may be incorporated into event sensor 14 (as in FIG. 9) or may be external to event sensor 14. The information from flicker analysis circuitry 116 (e.g., the detected frequency of LED flickering, the effective brightness of the LED, etc.) may be used by control circuitry 134 (e.g., circuitry 16 in FIG. 1, circuitry 44 in FIG. 2, circuitry 24 in FIG. 1, etc.) to modify image data from high-resolution HDR sensor 122. The modified image data from high-resolution HDR sensor 122 may be used to display an image on display 132.

The system of 100 may be a vehicular system where display 132 serves as a replacement for a mirror (e.g., a rear-view mirror or a side-view mirror) in the vehicle. Instead of a reflective surface serving as the mirror in the vehicle, a display may be used to display images captured of the vehicle's surroundings. Low-resolution event sensor 14 and high-resolution HDR sensor 122 may both capture images of the vehicle's surroundings. Data from the high-resolution HDR sensor 122 may be modified based on information from low-resolution event sensor 14 (e.g., flicker information determined by flicker analysis circuitry 116). The modified data from HDR sensor 122 may then display the corrected image on display 132. The corrected image displayed on 132 may be undulation-free due to the flicker analysis circuitry accounting for LED frequency in the scene.

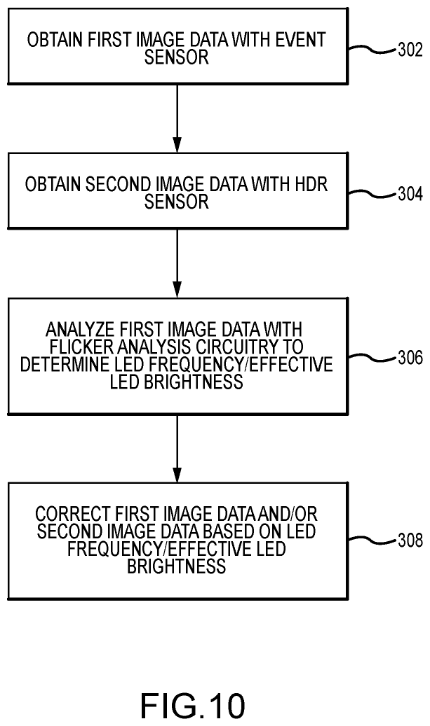

FIG. 10 is a flowchart of illustrative steps involved in operating a system with a low-resolution event sensor and a high-resolution HDR sensor of the type shown in FIG. 9. As shown, at step 302, first image data (e.g., event time stamps and corresponding light intensity) may be obtained with event sensor 14. At step 304, second image data may be obtained with HDR sensor 122. The image data from HDR sensor 122 may include brightness values for each imaging pixel obtained by accumulating charge over an integration time (e.g., HDR sensor 122 is a frame-based image sensor, not an event sensor). At step 306, flicker analysis circuitry (e.g., flicker analysis circuitry 116) may analyze the first image data from the event sensor to identify an LED flickering pattern/frequency in the captured scene. The flicker analysis circuitry 116 may also determine the effective LED brightness of the LED(s) in the scene. This information may then be used (e.g., by control and processing circuitry 44, storage and processing circuitry 24, or any other desired system component) to correct the first image data and/or the second image data at step 308. The corrected first and second image data may be free of undulations caused by LED flickering. A display may then be used to display the captured scene using the corrected second image data.

The foregoing is merely illustrative and various modifications can be made to the described embodiments. The foregoing embodiments may be implemented individually or in any combination.

What is claimed is:

1. A system comprising:
an event sensor pixel that is exposed to flickering light from a light-emitting diode, wherein the event sensor pixel is configured to output a light intensity signal; and
flicker analysis circuitry that is configured to receive the light intensity signal from the event sensor pixel and output an average brightness value that removes light intensity undulations caused by the flickering light from the light-emitting diode.

2. The system defined in claim 1, further comprising:
event detection circuitry that is configured to identify events based on the light intensity signal from the event sensor pixel.

3. The system defined in claim 2, wherein the event detection circuitry is configured to provide light intensity magnitudes associated with the events and time stamps associated with the events to the flicker analysis circuitry.

4. The system defined in claim 2, wherein the event detection circuitry is configured to provide light intensity magnitudes associated with the events and time stamps associated with the events to a buffer and wherein the flicker analysis circuitry is configured to receive the light intensity magnitudes and the time stamps from the buffer.

5. The system defined in claim 1, wherein the event sensor pixel includes a photodiode and wherein the light intensity signal is a photocurrent magnitude associated with the photodiode.

6. The system defined in claim 1, wherein the flicker analysis circuitry is configured to determine the average brightness value using time-averaging of the light intensity signal over one cycle of the light-emitting diode.

7. The system defined in claim 1, wherein the flicker analysis circuitry is integrated in the event sensor pixel.

8. The system defined in claim 1, wherein the flicker analysis circuitry is formed separately from the event sensor pixel.

9. The system defined in claim 1, wherein the event sensor pixel is part of an event sensor that includes an array of event sensor pixels and wherein each event sensor pixel has respective flicker analysis circuitry.

10. The system defined in claim 9, further comprising:
a frame-based image sensor formed separately from the event sensor.

11. The system defined in claim 10, wherein the frame-based image sensor has a higher resolution than the event sensor.

12. The system defined in claim 11, further comprising:
control circuitry configured to correct image data from the frame-based image sensor based on the average brightness value determined by the flicker analysis circuitry.

13. The system defined in claim 12, further comprising:
a display configured to display the corrected image data from the frame-based image sensor.

14. A system that is exposed to flickering light, comprising:
an event sensor comprising a plurality of event sensor pixels that generate first image data;
a frame-based image sensor comprising a plurality of imaging pixels that generate second image data;
flicker mitigation circuitry configured to identify a pattern of the flickering light based on the first image data; and
control circuitry configured to modify the second image data to remove undulations caused by the flickering light based on the pattern of flickering light from the flicker mitigation circuitry.

15. The system defined in claim 14, wherein each imaging pixel of the plurality of imaging pixels accumulates charge over an integration time.

16. The system defined in claim 14, wherein the first image data includes light intensity signals and corresponding time stamps.

17. The system defined in claim 14, further comprising:
a display that is configured to display the modified second image data.

18. A method of operating a system that includes an event sensor and flicker analysis circuitry, the method comprising:
obtaining image data using the event sensor;
detecting a flickering pattern in the image data using the flicker analysis circuitry; and
based on the detected flickering pattern, correcting the image data to produce undulation-free output.

19. The method defined in claim 18, wherein correcting the image data to produce undulation-free output comprises time-averaging a light intensity over the length of time of one flicker cycle.

20. The method defined in claim 18, wherein the system comprises an additional image sensor formed separately from the event sensor, the method comprising:
correcting additional image data from the additional image sensor based on the detected flickering pattern.
